(19) United States
(12) Patent Application Publication
(10) Pub. No.: US 2003/0081314 A1
(43) Pub. Date: May 1, 2003

(54) Illumination polarization conversion system

(75) Inventor: Patrick R. Destain, Loveland, OH (US)

Correspondence Address: Maurice M. Klee, Attorney at Law, 1951 Burr Street, Fairfield, CT, 06824, US

(73) Assignee: Corning Precision Lens Incorporated

(21) Appl. No.: 10/268,410

(22) Filed: Oct. 10, 2002

Related U.S. Application Data
(60) Provisional application No. 60/346,780, filed on Oct. 19, 2001.

(51) Int. Cl. F21V 9/14

(52) U.S. Cl. 359/485; 359/494; 362/19; 362/551; 362/560

(57) ABSTRACT

An illumination polarization conversion system is provided in which unpolarized light from a source (e.g., a lamp (10) and a light integrator (16)) is separated by a polarization converting relay (13) into first and second parts (e.g., S-polarized and P-polarized light) and the polarization of one of the parts is converted to the polarization of the other part (e.g., the S-polarized light is converted to P-polarized light). The converted and non-converted parts are then used to illuminate an object, such as, a polarization converting pixelized panel (12). The polarization converting relay (13) preferably has a telecentric or near telecentric exit pupil formed by placing a hard aperture stop substantially in the back focal plane of a lens unit (L3) located at the light exiting end of the relay (13).

### FIELD OF THE INVENTION

This invention relates to illumination systems for use with polarization converting pixelized panels and, in particular, to illumination systems which employ polarization conversion.

### BACKGROUND OF THE INVENTION

As known in the art, projection systems employing polarization converting pixelized panels (e.g., transmissive or reflective pixelized panels that use liquid crystal technology such as LCoS (Liquid Crystal on Silicon) reflective panels), require input light that is polarized. However, the light sources normally used in projection systems produce randomly polarized light. One approach to dealing with this fact is to filter the light from the light source so that it has a single polarization. Such filtering, however, wastes 50% of the output of the light source.

Another approach for dealing with the problem of random polarization is to separate the light produced by the source into two beams having different polarizations (e.g., a P-polarized beam and a S-polarized beam) and then to convert the polarization of one of the beams to match that of the other beam (e.g., to convert the S-polarized beam to P-polarization). This is preferable to the filtering approach since it utilizes more of the output of the light source. The present invention is concerned with such polarization conversion and, in particular, with the successful and economical integration of polarization conversion into an overall optical system for producing a high quality optical image on a projection screen.

Examples of polarization conversion systems which have been disclosed in the patent literature include those of U.S. Pat. Nos. 4,913,529, 5,884,991, and 6,139,157, the relevant portions of which are incorporated herein by reference.

### SUMMARY OF THE INVENTION

FIG. 1 shows the general structure of an optical system constructed in accordance with the present invention. As shown therein, the overall goal of the system is to take light from lamp 10, modulate the light by one or more pixelized panels 12 (e.g., three panels for red, green, and blue light, respectively), and then display the modulated light on a screen 14. Between the lamp and the pixelized panel(s) is a light integrator (homogenizer) 16 and between the pixelized panel(s) and the screen is a projection lens 18. The light integrator can be of the tapered tunnel type shown in FIG. 5 and the efficiency of the combination of such a tunnel with lamp 10 can be optimized in accordance with the procedures discussed in Simon Magarill, “First Order Property of Illumination System,” Novel Optical Systems Design and Optimization V, Jose M. Sasian and R. John Koshel, editors, Proc. SPIE, Vol. 4768, pp. 57-64, September, 2002.

An important aspect of the optical systems of the present invention is pupil management so as to achieve the twin goals of maximizing light transmission through the system while still accommodating the requirements of the various components of the system. In particular, polarization converting pixelized panels (e.g., LCoS panels) generally perform better when used with illumination systems and projection lenses which have telecentric or near telecentric pupils. As used herein, “near telecentric” means a pupil distance from the pixelized panel(s) of at least one meter.

In accordance with the invention, this preferred pupil location is achieved even though the system has optical paths of different lengths for polarization-converted light (e.g., originally S-polarized light which is converted to P-polarized light) and non-polarization-converted light (e.g., originally P-polarized light which remains P-polarized light). The invention achieves this result through the construction and operation of polarization converting relay 13 of FIG. 1.

As shown in FIG. 2, relay and polarization conversion system 13 includes: (1) a first lens unit, which as shown in FIG. 2 comprises two lens elements L1 and L2 which together have a principal plane PP1; (2) a polarization separator, which as shown is a grid polarizer (GP); (3) a folding mirror (FM); (4) a polarization converter, which as shown comprises a half-wave plate (HWP); (5) a hard stop aperture; and (6) a second lens unit, which as shown comprises a single lens element L3 and has a principal plane PP2.

The first and second lens units together function as a relay in that they image light from the exit end of light integrator 16 onto pixelized panel(s) 12. Thus, as a result of these units, the exit end of the light integrator and the surface of the pixelized panel are optical conjugates. However, because the relay system performs polarization conversion, the optical path lengths for polarization-converted (PC) light and for non-polarization converted (N-PC) light are not the same (e.g., as shown in FIG. 2, the optical path length for PC light is longer than the optical path length for N-PC light).

To allow for this difference in optical path lengths and still achieve a conjugate relationship between the exit end of the light integrator and the pixelized panel(s), the first lens unit is located so that its back focal plane is substantially at the exit end of the light integrator. In this way, the relay system is afocal and thus can accommodate the difference in path lengths for PC and N-PC light. Looked at another way, the first lens unit produces an intermediate image of the exit end of the light integrator at infinity and thus any defocus effect caused by the different path lengths washes out when the second lens unit images the intermediate image onto the pixelized panel(s).

Turning to the polarization conversion function of the relay, as shown in FIG. 2, this function is performed by a polarization separator, a folding mirror, and a polarization converter.

The folding mirror and polarization converter are of standard construction. Non-limiting examples of suitable folding mirrors include right-angle prisms, pentaprisms, and Dove prisms. Non-limiting examples of suitable polarization converters include half-wave plates and prism polarization rotators.

The polarization separator is preferably a grid polarizer of the type sold by MOXTEK of Orem, Utah, under the PROFLUX trademark. Compared to a cube-type polarization beam splitter, which can also be used but is less desirable, a grid polarizer has a number of benefits including: higher overall efficiency; lower sensitivity to the angle of incidence, i.e., a grid polarizer is better able to handle skew rays which are always present for an extended source even if collimated; higher polarization purity on both channels which makes conversion efficiency and throughput higher as well as improving contrast; and lower cost. In addition to cube-type polarization beam splitters and grid polarizers, the polarization separation function can also be performed by, for example, Foster prisms or other polarization splitter prisms using birefringent crystals.

As shown in FIG. 2, polarization conversion results in an overall asymmetric (decentered) optical system. It also results in different pupil positions for channel 1 light (the N-PC light) and channel 2 light (the PC light). In particular, the exit pupil of the lamp/light integrator combination is typically at infinity and the first lens unit images that pupil in its front (pixelized panel side) focal plane at a distance f1 from PP1. However, because the polarization separator separates the light from the lamp/light integrator combination into two parts and because the optical paths for those two parts are different, two pupils at different locations result, as shown by dotted lines in FIG. 2.

To address this problem, the polarization converting relay of the invention does two things: first, it introduces a hard stop aperture into the system, and second it locates the second lens unit of the system so that the hard stop aperture is substantially in the back (towards the source) focal plane of that unit. In this way, the relay system redefines the telecentricity of the overall system as seen from the pixelized panel(s). It thus resolves the problem of broken telecentricity caused by the two pupil locations. In doing so, it improves the contrast of the system by providing the pixelized panel(s) and projection lens with a proper aperture definition.

As shown in FIG. 2, the first and second channels are preferably decentered from the optical axis of the second lens unit by an equal amount, i.e., by a distance “D”. Moreover, D is preferably related to the f-number (f/#) of the hard stop aperture by the relationship:

D=f2/(4*f/#),

where f2 is the focal length of the second lens unit. A typical value for the f/# of the hard stop aperture is ˜2.8.

In addition to forming a telecentric image (or near telecentric image) of the hard stop aperture (i.e., a telecentric or near telecentric pupil), as discussed above, the second lens unit also images the intermediate image of the exit end of light integrator 16 onto pixelized panel(s) 12. Light engines used with pixelized panels often include a variety of optical components (e.g., PBS cubes) in close proximity to the pixelized panel(s) (see, for example, reference number 20 in FIGS. 3 and 4). This is especially so for reflective pixelized panels where both the illumination light and the image light are on the same side of the panel, but can also be true of transmissive panels.

To provide adequate space for these components, the second lens unit preferably is a weak unit, i.e., it preferably has a relatively long focal length so that the image of the exit end of the light integrator is located a long distance from the second lens unit. More precisely, the second lens unit (and thus the polarization converting relay as a whole) needs to have a long front (i.e., in the direction of the panel(s)) focal length (FFL) to provide adequate space between the light exiting end of the second lens unit and the surface of the pixelized panel(s). In particular, it is important to avoid the use of field lenses in the vicinity of the pixelized panel(s) as done in U.S. Pat. No. 6,139,157, since such lenses increase the complexity of the system and consume valuable space next to the panel.

As an example of suitable f2 and FFL values, f2 is 105.0 millimeters and FFL in air is 101 millimeters for the prescription of Table 1. More generally, in terms of the length “L” of the diagonal of the pixelized panel(s) used in the projection system, f2 is preferably greater than or equal to 2L, more preferably greater than or equal to 3L, and most preferably greater than or equal to 4L. Similarly, the FFL is preferably greater than or equal to 2L, more preferably greater than or equal to 3L, and most preferably greater than or equal to 4L. For reference, L for the pixelized panel of Table 1 is 21.15 millimeters.

To maximize the transfer of light from the lamp to the pixelized panel, the f2 to f1 ratio is preferably around 2. More generally, the ratio should be in the following range:

1.5≦f2/f1≦2.5.

This focal length ratio has been found to minimize the truncation of near and far fields for xenon arc lamps and thus maximize light throughput from the lamp to the pixelized panel(s). For other lamp types, ratios outside of this range may be suitable.

As shown in FIG. 2, the first lens unit consists of two lens elements L1 and L2, while the second lens unit consists of a single lens element L3. This is a preferred construction for the relay since it minimizes the cost and complexity of the system. Other configurations can, of course, be used in the practice of the invention, e.g., a single lens element could be used for the first lens unit.

Preferably, the same material is used for all of the relay's lens, e.g., for lens elements L1, L2, and L3 for the embodiment of FIG. 2. In particular, it is preferred to use an inexpensive crown glass such as BK7. In practice, it has been found that even with a glass of this type, the system exhibits a relatively low level of lateral color, as measured by the coincidence of the centroids of red, green, and blue light, when used with a tapered tunnel integrator which provides a large field with low divergence along the long axis of a rectangular pixelized panel. In particular, for the system of Table 1, the centroids of red, green, and blue light have been found to be coincident to within a few microns at the edges of a 18.43 mm×10.37 mm pixelized panel. This low level of lateral color is not only beneficial for systems using three individual pixelized panels for red, green, and blue light, but also means that the illumination system of the invention can be used in a scrolling color system where color images are produced sequentially and applied to a common pixelized panel rather than to separate panels.

If even further color correction and/or minimization of the remaining spherical aberration are desired, the second lens unit can be in the form of a color-correcting doublet or can include a diffractive surface which provides color correction, e.g., L3 can include a diffractive on one of its sides.

Additional features and advantages of the invention are set forth in the detailed description which follows, and in part will be readily apparent to those skilled in the art from that description or recognized by practicing the invention as described herein. It is to be understood that both the foregoing general description and the following detailed description are merely exemplary of the invention, and are intended to provide an overview or framework for understanding the nature and character of the invention.

### BRIEF DESCRIPTION OF THE DRAWINGS

FIG. 1 is a block diagram of the basic optical components of the projection system of the invention.

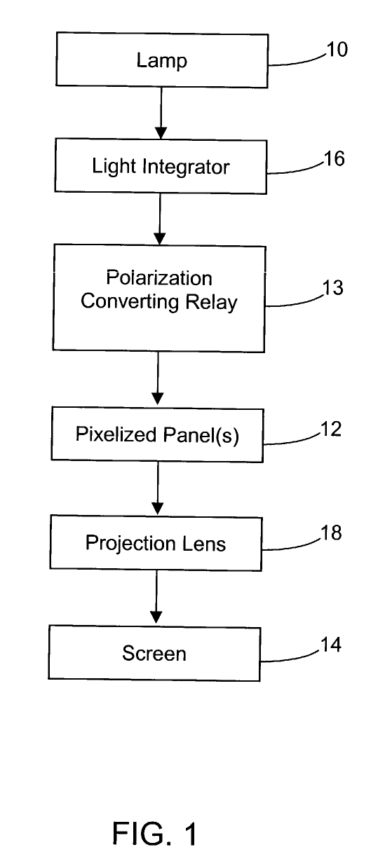

FIG. 2 is a schematic diagram of an embodiment of the polarization converting relay of the invention.

FIG. 3 is a schematic cross-sectional view of an embodiment of the projection system of the invention taken through the small aperture (high divergence) plane of the tunnel light integrator. This is also the plane of the small dimension of the rectangular pixelized panels.

FIG. 4 is a schematic cross-sectional view of an embodiment of the projection system of the invention taken through the tapered aperture (low divergence) plane of the tunnel light integrator. This is also the plane of the large dimension of the rectangular pixelized panels and is the plane in which polarization is converted by the polarization conversion system (PCS).

FIG. 5 is a perspective view of the tunnel light integrator of FIGS. 3 and 4.

The foregoing drawings, which are incorporated in and constitute part of the specification, illustrate preferred embodiments of the invention, and together with the description, serve to explain the principles of the invention. It is to be understood, of course, that both the drawings and the description are explanatory only and are not restrictive of the invention.

### DESCRIPTION OF THE PREFERRED EMBODIMENTS

As discussed above the present invention provides a polarization converting relay for use in a projection system employing one or more polarization converting, pixelized panels, e.g., one or more LCoS reflective panels. The polarization converting relay includes a hard aperture stop to address the problem of different pupil locations for the two polarized beams produced during polarization separation and conversion.

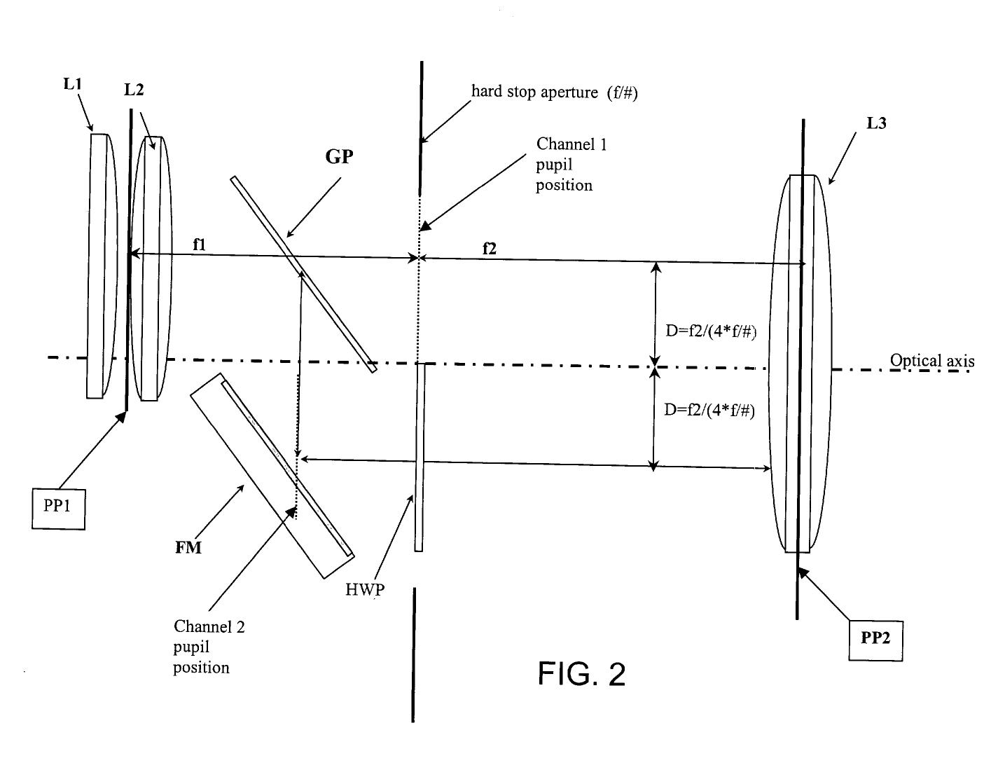

As shown in FIG. 2, the hard aperture stop can be coincident with the pupil location for the shorter of the two optical paths (channel 1 in FIG. 2) and not coincident with the pupil location for the longer optical path (channel 2 in FIG. 2). In particular, in FIG. 2, the hard aperture stop is on the pixelized panel side of the pupil for the longer optical path. Alternatively and preferably, the hard aperture stop is not coincident with the location of either pupil, but rather is located between them. This is the case for the relay of Table 1. Other locations for the hard aperture stop besides the foregoing two examples can be used in the practice of the invention if desired. In all cases, the hard aperture stop will not be coincident with at least one of the two pupils produced by the polarization conversion system.

The aperture stop is referred to as a “hard” aperture stop (or alternatively as a “hard” stop aperture) because it is intentionally included in the polarization converting relay. It may be formed by any standard method known in the art, e.g., it can be part of the mechanical mount for one or more of the other optical components of the relay or it can be a separate component.

As also discussed above, the second lens unit of the polarization converting relay is located so that the back (towards the lamp) and front (towards the panel) focal planes of the unit are substantially coincident with the hard aperture stop and the surface of the pixelized panel(s), respectively. Thus, the second lens unit is substantially optically equidistant between the hard aperture stop and the pixelized panel(s). When planar glass elements (e.g., PBS cubes) are present between the second lens unit and the pixelized panel(s), the physical distance (as opposed to optical distance) between the second lens unit and the pixelized panel(s) will be greater than the physical distance between the second lens unit and the hard aperture stop. In particular, for each planar glass element, the physical distance will be increased by t*(n−1)/n, where t is the thickness of the element and n is its index of refraction.

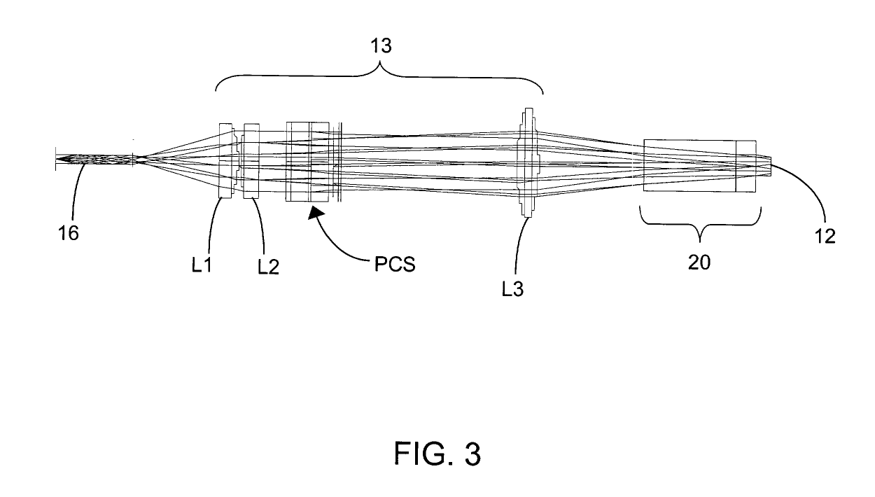

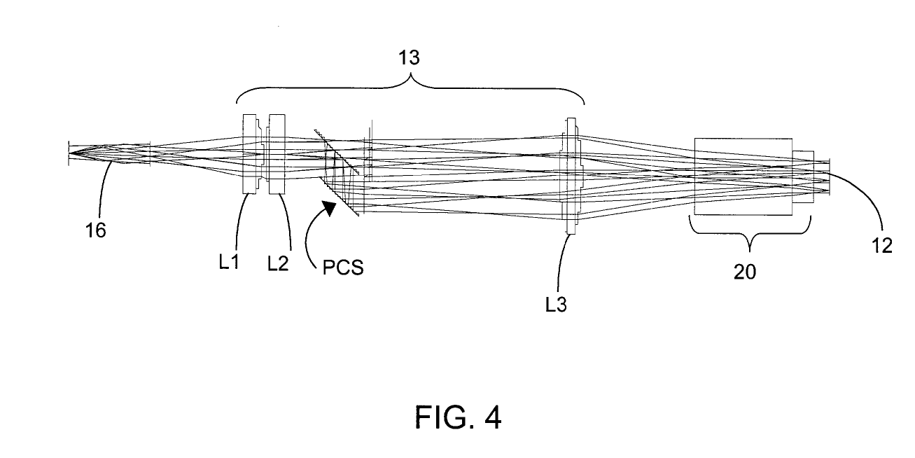

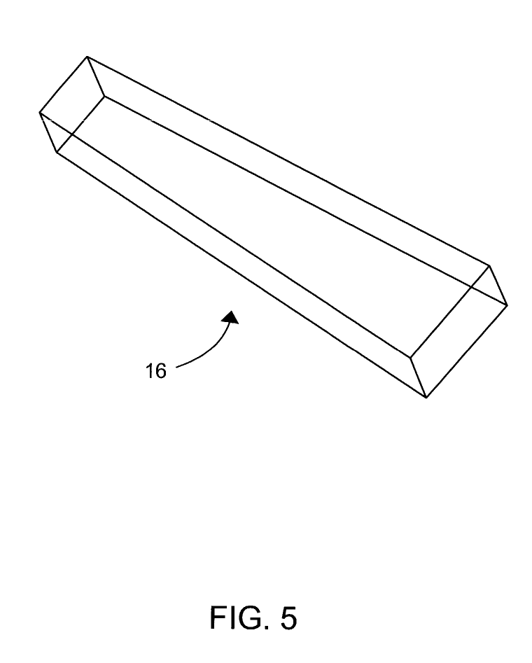

Without intending to limit it in any manner, the present invention is more fully described by the specific example of Table 1 and FIGS. 3-5. FIGS. 3 and 4 were prepared from the prescription of Table 1 using the ZEMAX optical design program sold by Focus Software Inc. (Tucson, Ariz.). All dimensions given in the table are in millimeters. The clear aperture values are radius values for circular apertures and full width values for rectangular apertures.

This example uses a tapered integrator tunnel having mirrored internal surfaces. In particular, the tunnel has a 5.7 millimeter×6.07 millimeter input face and a 5.7 millimeter×9.9 millimeter output face. The tapering reduces the divergence of the illumination in the direction of the long axis of the pixelized panel(s). This, in turn, reduces lateral color at the pixelized panel(s), allowing the relay to consist of just three lens elements, all of which are made of an inexpensive glass, e.g., BK7. In addition to having low lateral color, relays using inexpensive BK7 glass also have low longitudinal color.

By performing polarization conversion, the relay system of Table 1 achieves approximately a 25-35% increase in light throughput compared to an illumination system which uses only one polarization of the randomly polarized light produced by the illumination lamp.

Although preferred and other embodiments of the invention have been described herein, further embodiments may be perceived by those skilled in the art without departing from the scope of the invention.

TABLE 1

| Item name | Radius | Thickness | Glass | C.A (mm) or full width | | |
|---|---|---|---|---|---|---|
| Integrator | | 45 | Mirror | 5.7 × 6.07 | Rotx | Decy |
| | | 43.683(th1) | air | 5.7 × 9.9 | | |
| Lens (L1) | Inf | 9.913 | BK7 | 38 | | +10.142 |
| | −52.3512 | 1.1 | AIR | 38 | | +10.142 |
| Lens (L2) | 74.1752 | 9.913 | BK7 | 38 | | +10.142 |
| | −213.476 | 25.700(th2) | AIR | 38 | | +10.142 |
| GP | | 0.75 | BK7 | 40*25.6 | 45 deg | +9.08 |

(N-PC)channel
(Channel 1)

| | | | | |
|---|---|---|---|---|
| GP-stop | | 11.4 | AIR | |
| STOP | | | | 35.2 |
| STOP-L3 | 101.3(th3) | AIR | | |

(PC) channel
(Channel 2)

| GP-FM | 20.285 | AIR | (decenter along Y) | | |
|---|---|---|---|---|---|
| FM | | MIRROR | 40 × 26 | 45 deg | −10.142 |
| FM-STOP | 11.4 | AIR | | | |
| HWP | | | 40*20.3 | | −10.142 |
| STOP-L3 | 101.3(th3) | AIR | | | |
| Lens (L3) | 108.2851 | 11 | BK7 | 56 | |
| | −106.6912 | 0 | | 56 | |
| | | 51.187 | AIR | | |
| PBS (cumulative | Infinity | 47 | SF2 | 26 × 36 | |
| thickness) | Infinity | | | 26 × 36 | |
| | | 0.001 | AIR | | |
| BK7 | Infinity | 10.5 | BK7 | 26 × 26 | |
| (cumulative | | | | | |
| thickness) | | | | | |
| | | 7 | AIR | 26 × 26 | |
| LCOS plane | | 0 | | 18.43 × | |
| | | | | 10.37 | |

What is claimed is:

1. A polarization converting relay which receives unpolarized light from a source and transmits polarized light to an object to be illuminated, said relay comprising:
(a) a polarization separator for separating the unpolarized light from the source into first and second parts based on polarization; and
(b) a polarization converter for converting the polarization of one of those parts;
wherein:
(i) the first and second parts pass through the relay along optical paths which are of different lengths; and
(ii) the relay has an exit pupil which is telecentric or near telecentric.

2. The polarization converting relay of claim 1 wherein:
(a) the source has an exit pupil;
(b) the relay comprises:
(i) a lens unit comprising at least one lens element between the source and the polarization separator; and
(ii) a hard aperture stop between the polarization separator and the object to be illuminated;
wherein:
(1) the lens unit and polarization separator produce two images of the source's exit pupil; and
(2) the hard aperture stop is not coincident with at least one of said two images.

3. The polarization converting relay of claim 2 wherein the hard aperture stop is not coincident with either of said two images.

4. The polarization converting relay of claim 3 wherein the hard aperture stop is between the two images.

5. The polarization converting relay of claim 2 wherein the lens unit consists of two lens elements.

6. The polarization converting relay of claim 1 wherein the relay comprises:
(a) a hard aperture stop located between the polarization separator and the object to be illuminated; and
(b) a lens unit between the hard aperture stop and the object to be illuminated, said lens unit having a principal plane;
wherein the spacing between the hard aperture stop and the principal plane is substantially equal to the focal length of the lens unit in the direction of the source.

7. The polarization converting relay of claim 6 wherein:
(a) the lens unit has an optical axis;
(b) the first and second parts are decentered from said optical axis by a distance D given by:
D=f/(4*f/#),
where f is the focal length of the lens unit and f/# is the f-number of the hard aperture stop.

8. The polarization converting relay of claim 6 wherein the lens unit consists of a single lens element.

9. A polarization converting relay which receives unpolarized light from a source and transmits polarized light to an object to be illuminated, said relay comprising:
(a) a first lens unit which receives unpolarized light from the source;
(b) a polarization separator which receives unpolarized light from the first lens unit and separates that light into two parts based on polarization;
(c) a polarization converter which receives one of the two parts and converts the polarization of that part; and
(d) a second lens unit which receives polarized light from the polarization separator and the polarization converter and transmits that light to the object to be illuminated;
wherein:
(i) the first lens unit has a focal length f1;
(ii) the second lens unit has a focal length f2; and
(iii) 1.5≦f2/f1≦2.5.

10. A polarization converting relay which receives unpolarized light from a source and transmits polarized light to an object to be illuminated, said relay comprising:
(a) a first lens unit which receives unpolarized light from the source;
(b) a polarization separator which receives unpolarized light from the first lens unit and separates that light into two parts based on polarization;
(c) a polarization converter which receives one of the two parts and converts the polarization of that part; and
(d) a second lens unit which receives polarized light from the polarization separator and the polarization converter and transmits that light to the object to be illuminated;
wherein the polarization separator is a wire grid polarizer.

11. An optical system comprising:
(a) a source of unpolarized light;
(b) a polarization converting relay which receives unpolarized light from the source; and
(c) at least one polarization converting pixelized panel which receives light directly from the relay without any intervening elements having optical power;
wherein:
FFL≧2L,
where FFL is the front focal length of the relay in the direction of the at least one polarization converting pixelized panel and L is the diagonal of the panel.

12. An optical system comprising:
(a) a source of unpolarized light comprising:
(i) a lamp; and
(ii) a light integrator;
(b) a polarization converting relay which receives unpolarized light from the source, said relay comprising:
(i) a first lens unit comprising at least one lens element; and
(ii) a second lens unit comprising at least one lens element; and
(c) at least one polarization converting pixelized panel which receives light from the relay;
wherein:
(i) the at least one polarization converting pixelized panel is a rectangular panel having a long axis;
(ii) the integrator is a tapered integrator which provides a large field with low divergence along the long axis of the panel; and
(iii) all lens elements of the first and second lens units comprise crown glass.

13. The optical system of claim 12 wherein the crown glass is BK7.

14. An optical system comprising:
(a) a source of unpolarized light;
(b) a polarization converting relay according to claim 1; and
(c) at least one polarization converting pixelized panel which constitutes the object to be illuminated.

15. The optical system of claim 14 wherein:
(i) the source of unpolarized light comprises a lamp and a light integrator which has an exit end; and
(ii) the polarization converting relay images the exit end of the integrator onto the at least one polarization converting pixelized panel.

16. The optical system of claim 15 wherein:
(i) the polarization converting relay comprises a first lens unit and a second lens unit; and
(ii) the first lens unit has a principal plane and the spacing between that plane and the exit end of the integrator is substantially equal to the focal length of the first lens unit in the direction of the source.

17. The optical system of claim 16 wherein:
(i) the polarization converting relay comprises a hard aperture stop located between the first and second lens units; and
(ii) the second lens unit has a principal plane and the spacing between that plane and the hard aperture stop is substantially equal to the focal length of the second lens unit in the direction of the source.

18. The optical system of claim 17 wherein the polarization separator is a wire grid polarizer.

19. The optical system of claim 17 wherein:
(i) the at least one polarization converting pixelized panel is a rectangular panel having a long axis;
(ii) the integrator is a tapered integrator which provides a large field with low divergence along the long axis of the panel; and
(iii) all lens elements of the first and second lens units comprise crown glass.

20. The optical system of claim 19 wherein the crown glass is BK7.

21. The optical system of claim 17 wherein:
(i) the at least one polarization converting pixelized panel receives light directly from the relay without any intervening elements having optical power; and
(ii) FFL≧2L,
where FFL is the front focal length of the second lens unit in the direction of the at least one polarization converting pixelized panel and L is the diagonal of the panel.

22. The optical system of claim 17 wherein:
(i) the first lens unit has a focal length f1;
(ii) the second lens unit has a focal length f2; and
(iii) 1.5≦f2/f1≦2.5.

23. The optical system of claim 17 wherein the first lens unit consists of two lens elements and the second lens unit consists of one lens element.
